(19) United States
(12) Patent Application Publication
(10) Pub. No.: US 2004/0218737 A1
(43) Pub. Date: Nov. 4, 2004

(54) Telephone system and method

(76) Inventor: Anthony Gerard Kelly, Drumcondra (IE)

Correspondence Address: GORDON & REES LLP, 101 WEST BROADWAY, SUITE 1600, SAN DIEGO, CA, 92101, US

(21) Appl. No.: 10/772,874

(22) Filed: Feb. 5, 2004

(30) Foreign Application Priority Data
Feb. 5, 2003 (IE) S2003/0072

(51) Int. Cl. H04M 1/64; H04M 11/00; H04L 12/66

(52) U.S. Cl. 379/88.18; 379/88.17; 370/352

(57) ABSTRACT

A telecommunications system and method is disclosed which introduces events into a current voice call of a telephone between at least two telephone users in a telecommunications network. The event is typically an audio file which can be introduced into the current voice call, in response to an event initiated by one of the telephone users. The invention can also be employed with Interactive Voice Response (IVR) systems for delivering audio, visual and translated information to a user in a telecommunication network. The invention is particularly suitable for use in Telecommunication Relay Services (TRS) systems. In another embodiment the invention provides a way of converting audio data to a visual representation and vice versa for telecommunication users.

### FIELD OF THE INVENTION

The present invention relates to a method and system of introducing events into a current voice call. In particular the invention relates to a method and system which utilizes an Interactive voice response (IVR) system for delivering audio, visual and translated information to a user in a telecommunications network.

### BACKGROUND TO THE INVENTION

Interactive Voice Response (IVR) systems collect data in conjunction with a voice call. The data may include information such as an account number. This data may be used to retrieve information from a server related to the caller. The IVR is usually implemented on a client's system, which is coupled to the server. There are many hundreds of IVR systems in operation. There is no standardisation of hardware or operating systems. Many of the proprietary systems have the capability to interface with the internet. Some systems can receive an input from the internet and output to a non-connected system such as an SMS to a mobile telephone.

Other IVR systems use inputs from the internet to set up a voice call to a phone. This typically involves Computer Telephone Integration (CTI), Private Branch Exchange (PBX) or other switching mechanism. The human agent or call assistant will typically receive the user's telephone number over the internet and then call the user directly over a direct telephone connection. There is no connection between the internet and the telephone call. In some cases, the human agent and the caller can interact using a web server to share information.

Telecommunication Relay Services (TRS) utilise a typical IVR system. TRS is a service which provides Deaf and Speech Impaired individuals access to normal telephony services. TRS and variants of the TRS principles are available in many countries. The current technical solution for provision of voice telephony services to deaf and Speech Impaired individuals is to involve a human intermediary usually called a Communications Assistant (CA). The primary purpose of a CA is to read text input from one party of a telephone call and relay or voice that text out to the other party. A CA will also listen to a speaking party and relay that information as text to the other party. A CA is currently involved in all voice based TRS services. TRS voice telephony can be accessed by either a Computer connected to an IP Relay service via the internet, or a TTY machine connected to a standard telephone line. However a problem with this service is that TRS is not reliable as it is limited to a CA been available at the time a user wishes to make a call. The service is very expensive to maintain. Users of the service feel their privacy is compromised by the necessity of a communications assistant. Another problem is that it is difficult to have a meaningful communication session as there is a time lag by using the CA. A different CA can be connected to a user each time a connection is made making the user uncomfortable to a strange voice of the CA. The TRS service is limited to the language skills of the CA, in many cases the CA can only communicate in one language. Similar problems exist for hearing impaired or deaf individuals as the user must type the complete text. The CA must voice the text to the hearing person. The hearing person must reply to the CA, then the CA must type the complete response to the user.

The above problems can equally be applied to language translation call services. Currently a human interpreter must be available who can interpret between two languages. Such interpreters are rarely available on demand 24 hours a day 7 days a week.

US patent publication number US2003/0005076 ‘Bellsouth Intellectual Property Corporation’ discloses an IVR system which provides a Visual Interactive Voice Response (VIVR) system for delivering information to a user during a VIVR session, comprising a VIVR Server operative to send voice-based information to a telephone and to send visual-based information to a networking device, in response to the receipt of a VIVR session request and a session identification number. A database operative is required to maintain a VIVR session identification number (session ID), which identifies the telephone and the networking device. This system requires an AIN (Artificial Intelligent Network) system. This system only works when the Voice and data connections are on the same network, which is a limitation. This will not function with all telephones worldwide. The session identification number is generated automatically by the VIVR/AIN. This system cannot guarantee to automatically generate a unique session ID for instance when the data component originates on a corporate LAN, and the Voice Component originates behind a corporate PBX. The system requires access to the session ID database by components on the AIN this is not a practical solution, as the VIVR system also claims to identify the networking device and uses the IP address, the Internet directory number and the Voice directory number. This system assumes only one user per Voice communications channel. The function and scope of this system is limited by access to a predetermined number of network configurations.

Existing IVR systems maintain a continuous telephone connection. Another problem with sending information, in particular, for example, audio files, is that it takes time to transfer or stream audio files over the internet and the transmission time is dependent on the available bandwidth in the network. In general telephone systems have a guaranteed bandwidth to facilitate conversation. Existing problems in the music industry is the problem of music piracy wherein songs are downloaded illegally from the internet.

### OBJECT OF THE INVENTION

An object of the present invention is to provide a system and method of introducing events, such as audio files, into a current voice call in a telecommunication network.

Another object of the present invention is to provide a TRS (Telecommunications Relay Service) system and method which provides Deaf and Speech Impaired individuals with improved access to normal telephony services.

A further object of the present invention is to provide a language translation system and method for use over a voice call between at least two users. In yet another object of the present invention there is provided a system and method for accessing and controlling audio information over a voice call.

### SUMMARY OF THE INVENTION

According to the present invention, there is provided, as set out in the appended claims, a method of introducing events into a current voice call of a telephone between at least two telephone users in a telecommunications network comprising:

routing said voice call via an Interactive Voice Response (IVR) system;

linking said interactive voice response (IVR) system to a server in response to an input from an internet application initiated by at least one of said telephone users;

recognising the input as an event by the IVR system;

outputting the event over said current voice call; and

wherein said event is an audio file associated with said IVR system which is delivered over said current voice call to at least one telephone user in response to the input initiated by one or other of said other telephone users.

The advantage of the present invention is that telephone users can visually interact with an IVR system. This affords the telephone user the opportunity to select an audio file residing on an IVR system, via a Visual Display and listen to that file over the telephone connection or line. If that telephone connection or line is connected to other users via the IVR two or more users can use their respective Visual Displays to transmit audio information to each other in real time, irrespective of any data bandwidth limitations or restrictions.

Preferably there is provided the further step of selecting an icon or hyperlink by one of said telephone users from a web page on a computer screen triggering the event connected to the server and the IVR system. Optionally the method comprises the further steps accepting inputs from said web pages to an IVR system and outputting as an event to a selected current voice call connection. Ideally there is provided a VoIP channel for the current voice call.

Preferably the invention carries out the steps of:

storing a plurality of audio files on said IVR system;

receiving at said IVR system said event from said server; and

outputting said audio file over said current voice call selected from said plurality of audio files in response to said event in real time.

Suitably the invention comprises the step of allowing multiple voice call connections interact with the IVR system simultaneously from several web pages.

Ideally the method comprises the further step of assigning an identifier to route the audio file to said voice call in response to said event wherein said IVR system selects said audio file from said event when an event is received by said IVR system.

Optionally said identifier is generated from an Out Dialled Number (ODN), from the IVR to one of said telephone users receiving a telephone voice call.

Suitably said identifier is generated from a Call Line Identifier (CLI), identified from one of said telephone users initiating a telephone voice call.

Optionally, said identifier is generated from a cookie or IP address or a browser script, identified from one of said telephone users initiating a telephone voice call.

Alternatively the method comprises the step of visually indicating a unique identifier to via one of said users computer terminal and requesting the caller input this identifier by means of a telephone or telephony device when connected to the IVR system.

In another embodiment the method comprises the step of providing audio instructions containing a unique identifier pertaining to the users current voice call, and requesting the user to enter this identifier into the users computer terminal.

Preferably the invention comprises the further steps of:

inputting text to said web server over an internet application by at least one of said telephone user;

assigning a file name to said inputted text;

transmitting said file name to said IVR system said filename been recognised as an event; and

outputting an audio file from said IVR system representing said inputted text over said current voice call to said other user.

Ideally the invention carries out the additional steps of:

inputting audio information to a speech to text module via said IVR system by at least one of said telephone users;

outputting a text string by said server representing said inputted audio information to an interface viewable by said other user.

Suitably the invention carries out the steps of:

providing a status protocol between said IVR system and said telephone users; and

configuring said protocol to visually indicate to said users the status of said current voice call connection via an internet enabled screen of said users.

In another embodiment of the present invention there is provided a method of introducing events into a current voice call of a telephone between at least two telephone users in a telecommunications network comprising:

routing said voice call via an interactive voice response (IVR) system;

linking said interactive voice response (IVR) system to a server in response to an input from an internet application initiated by at least one of said telephone users;

selecting a translation application by at least one of said users;

inputting text to be translated by said user to said server to provide an event;

receiving at said IVR system said event from said server;

outputting the event over said current voice call; and wherein said event is an audio file associated with said IVR system which is a translation of said inputted text to at least one telephone user in response to said selected translation application.

The advantage of this embodiment is that conversation can be carried out between two users in different languages in real time. The delay between the user input and the initial audio stream to the user's telephone is measured in milliseconds only, which is perceived by the user to be almost instant or received in real time.

Ideally the invention provides the steps of:

providing a status protocol between said IVR system and said telephone users; and

configuring said protocol to visually indicate to said users the status of said current voice call connection via an internet enabled screen of said users.

Preferably said status protocol comprises the steps of:

visually indicating to said user that no call connection has been made; and

visually indicating a procedure to establish a call connection between said users.

Optionally said status protocol comprises the steps of:

visually indicating to said user that a call connection has been made; and

visually indicating the readiness of said voice call connection to accept an input from one of said users.

In another embodiment of the present invention there is provided a method of controlling an audio output from an IVR system outputted to a users device by a visual control means comprising the steps of:

linking a first IVR system to a second IVR system in response to an input from an internet application initiated by a user;

selecting an audio application associated with said second IVR system in response to said input;

converting said audio application to visual information at said first IVR system;

presenting said audio application as a visual information on said users device from said first IVR system; and

selecting a portion of said visual information by said user wherein said selected portion of information triggers a desired audio output to be delivered to said user over a voice call.

An advantage of this embodiment is that most telephonic devices are limited to the 12 touchtone keys of the telephone keypad. This invention facilitates increased selection capability for users, as a visual display can provide many more options than a telephone keypad. Also, the function of user selections can be readily identified as text relating to each function can be viewed by the users without the need to wait for audio instructions over the telephone line. Also, the present invention improves several aspects of voice based TRS services.

Optionally there is provided the additional steps of

initiating said voice call between said user and said IVR system; and

delivering a selected audio application to said user from said IVR system over said voice call.

There is also provided a computer program comprising program instructions for causing a computer program to carry out the above method, which may be embodied on a record medium, carrier signal or read-only memory.

In another aspect of the present invention there is provided a system for introducing events into a current voice call of a telephone between at least two telephone users in a telecommunications network comprising:

means for routing said voice call via an Interactive Voice Response (IVR) system;

means for linking said interactive voice response (IVR) system to a server in response to an input from an internet application initiated by at least one of said telephone users;

means for recognising the input as an event by the IVR system;

means for outputting the event over said current voice call; and

wherein said event is an audio file associated with said IVR system which is delivered over said current voice call to at least one telephone user in response to the input initiated by one or other of said other telephone users.

In a further aspect of the present invention there is provided a system for introducing events into a current voice call of a telephone between at least two telephone users in a telecommunications network comprising:

means for routing said voice call via an interactive voice response (IVR) system;

mean for linking said interactive voice response (IVR) system to a server in response to an input from an internet application initiated by at least one of said telephone users;

means for selecting a translation application by at least one of said users;

means for inputting text to be translated by said user on said server to provide an event;

means for receiving at said IVR system said event from said server;

means for outputting the event over said current voice call; and

wherein said event is an audio file associated with said IVR system which is a translation of said inputted text to at least one telephone user in response to said selected translation application.

In a final embodiment of the present invention there is provided a system for controlling an audio output from an IVR system outputted to a users device by a visual control means comprising:

means for linking a first IVR system to a second IVR system in response to an input from an internet application initiated by a user;

means for selecting an audio application associated with said second IVR system in response to said input;

means for converting said audio application to visual information at said first IVR system;

means for presenting said audio application as a visual information on said users device from said first IVR system; and

means for selecting a portion of said visual information by said user wherein said selected portion of information triggers a desired audio output to be delivered to said user over a voice call.

### BRIEF DESCRIPTION OF THE DRAWINGS

The invention will be more clearly understood from the following description thereof, given by way of example only, with reference to the accompanying drawings, in which:

FIG. 1 is an overview of the present invention,

FIG. 2 is a layout of the architecture of the IVR system and FIG. 1

FIG. 3 is an alternative embodiment of the present invention,

FIGS. 4 and 5 is an application of the present invention for voice translation,

FIGS. 6 and 7 is an application of the present invention for text to speech translation, and

FIG. 8 illustrates an alternative architecture of the present invention for a deaf user.

### DETAILED DESCRIPTION OF THE DRAWINGS

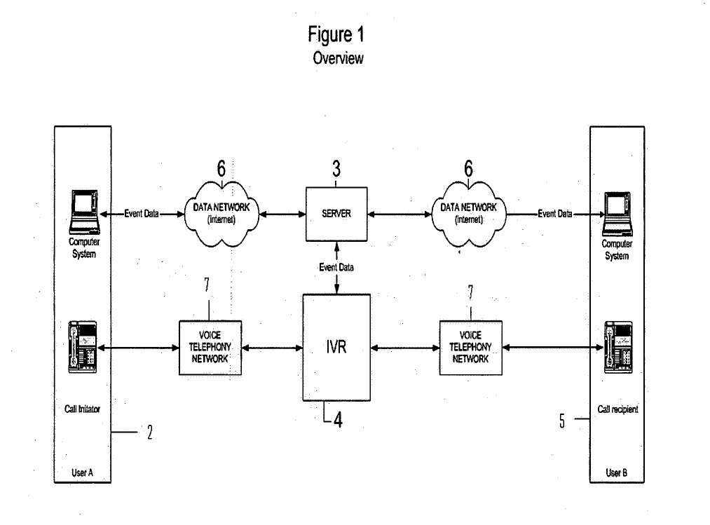

Referring now to FIG. 1, there is illustrated an overview of the present invention, indicated generally by the reference numeral 1. A call initiator 2, in the form of a user with a telephone and a computer connected to the internet, makes an internet 6 connection to a server 3. The call initiator 2 then uses a telephone to call a call recipient 5 via an interactive voice response (IVR) system 4 over a typical telephone network 7, for example a PSTN. There are two technical components of every voice call, the caller's own telephone number (CLI) and the recipient's telephone number (ODN). The invention utilises these components to route the output of the internet commands via the IVR system 4 to the corresponding telephone connections in a reliable manner. These two components can be entered in a text box by the call initiator 2 on the computer in a text box of a web page.

The IVR system 4, if instructed by the call initiator 2, will connect the caller to the call recipient 5. Again, the call recipient 5 will have the telephone and a computer with an internet connection. The call initiator 2 and the call recipient 5 can now converse as per a normal conversation.

Ideally the server 3 is a HTTP server which can employ Secure Socket Layer (SSL) or other encryption mechanisms when required by the application. The server 3 can also perform FTP functions when applicable to an application required. The present description discusses a user which can be the call initiator 2 or call recipient 5. The call initiator and recipient 2, 5 are depicted in FIG. 1 as having access to both a telephone and a computer connected to the internet for illustration purposes. It will be appreciated to the person skilled in the art that the telephone and computer could form one device, for example an internet enabled mobile telephone. Therefore, it is envisaged that the present invention can be carried out on a single device that provides both voice call and internet connection capabilities. A voice call should be interpreted broadly to encompass any voice call over a communication network to include both land and wireless voice connections.

In operation, the call initiator 2 is connected to the web server 3 via a computer internet connection. The call initiator 2 makes a voice call which is routed via the interactive voice response system 4 to the call recipient 5 over the telephone network 7. While the caller is connected to the server 3, the caller can instruct the IVR system 4 to deliver or play sounds over the current telephone connection. This is achieved by clicking an icon or hyperlink on the computer screen, having the internet connection to the web server 3. The clicking of the icon triggers an event to instruct the IVR system 4 via the web server 3 to deliver or play an audio file over the telephone connection. Similarly, the call recipient 5, if is connected to the web server 3, can also instruct the IVR system 3 to play audio files over the same telephone conversation. The net result is that one or both parties of the voice call can introduce external sounds in real time to the conversation, as required, as long as they are connected to the web server 3 in real time.

It will be appreciated that all commands relevant to an IVR application and its functions can be placed visually on a web page, which can be seen by both the call initiator 3 and the call recipient 2. When the call initiator 2 clicks the icon or hyperlink, the IVR system 3, connected to the user's telephone, responds immediately. The web page can be updated in response to the user's choices. When the call initiator clicks the relevant link on a web page, the audio file is played in real time over the telephone connection irrespective of the original audio file size. This is because the audio file is associated with the IVR system 4 or can store directly on the IVR system 4. Therefore, it is not necessary to download the audio file over the telephone connection but simply play the audio file down the telephone line. This ensures instant response means because when the user for example clicks “yes” on the web page, the audio file “yes” is played over the telephone instantly. It will be appreciated that the telephone connection does not have to be limited to two callers. As the file name together with the unique identifiers called the ‘event data’ is only being transmitted from the web server 3, it is normally only a fraction of the size of the actual audio file. It will be sent irrespective of the user's internet bandwidth. All audio files are stored on the IVR system 3 or retrieved from another source to the UVR. This means that each event is triggered and carried out in real time. It has been found that a particularly suitable means of providing the voice call is over a VoIP voice channel.

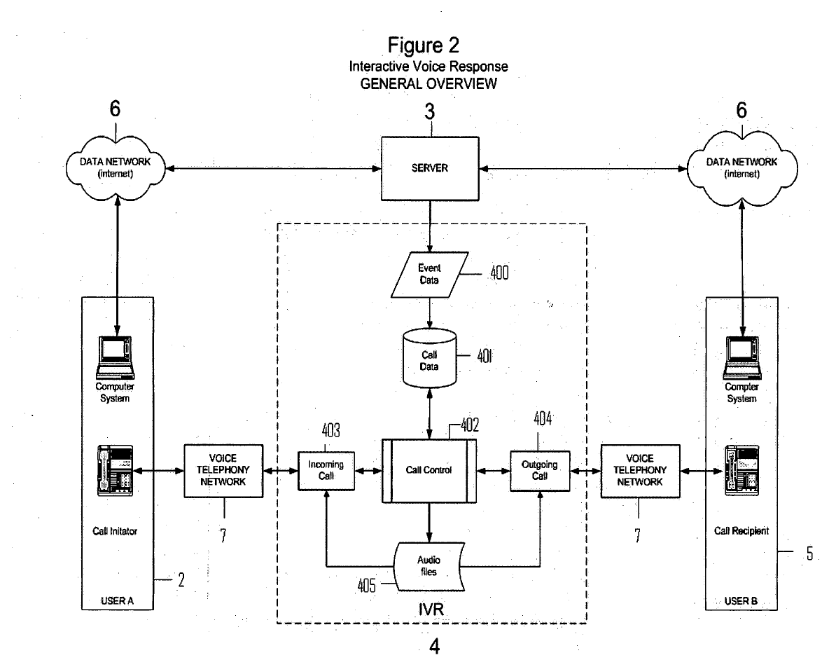

FIG. 2 is the same as FIG. 1 except the IVR system is shown in more detail. Typical IVR systems are designed to accept DTMF input from a connected voice telephony channel and use this input to execute instructions according to a software program assigned to that channel. The program will normally instruct a Call Control mechanism 400-405 to access and play an audio file to a caller listening to that voice channel by means of a telephone handset. In the case of IVR systems configured to accept voice or audio input, the software program may be a Fax or Voice XML application. The Call Control module 402 is a representation of several standard telephony features common to IVR systems. Among these features is the facility to route an incoming voice channels to specific destinations by software commands, access and play audio files through one or more voice channels simultaneously or route the input for further processing. In each case the user input to the IVR originates from a telephone device connected to at least one voice channel on the IVR. Telephone devices are normally limited to 12 touchtone keys, there are 16 DTMF tones 0-9, *, #, A, B, C, D. (Ref: ANSI T1.401-1988 Section 7.2).

The configuration shown in FIG. 2 provides an alternative method of providing user input to the IVR and outputting the assigned program responses in real time to a callers listening and speaking through designated voice channels on the IVR. This is achieved by:

Submitting the user input in the form of data over the internet.

Receiving the input data at a server connected to the IVR.

Formatting and relaying this ‘event data’ to a Call Data management module on the IVR.

The Call Data management module 401 contains a data table of all currently active voice channels and status information pertaining to those channels on the IVR. When the event data ‘identifier field’ references an active voice channel it will trigger an action within the Call Data management module 401 which will instruct the Call Control system to execute a program according to further instructions contained in the event data.

If the event data module 400 an identifier field contains no references to an active voice channel it will either activate a new voice channel if valid instructions are contained in the event data or perform no action and return the call status through the server to the client. FIG. 2 illustrates two users 2,5 connected to each other via the IVR. Both users 2, 5 can speak and hear a per a normal voice telephony conversation. If the event data submitted by either user over the internet contains a valid channel identifier then that event may be output through the associated voice channels to one of the parties or both parties simultaneously. Either party can submit data a long as the channel Identifier corresponds to an active voice channel referenced in Call Data management module 401. The event data module 400 can contain several data fields amongst which are the following:

A: Channel Identifier Field

This a unique identifier in order to effect the program response through correct voice channels associated with the program.

B: The Data Field

This will normally contain the filename of an audio file accessible by the Call Control system. This field may also contain text data input by the user.

C: Call Status Field

This data contains information pertaining current status of voice channels identified by the channel identifier. Call status data is returned to the client computer and can be visually displayed.

D: Connection Field:

This data contains instructions which when interpreted by the associated program will instruct the Call Control system to perform many standard IVR functions, including connecting and disconnecting channels and routing channels to alternative destinations. Setting up conference facilities or retrieving data from an alternative source and system.

E: Language IN field

In the case of text input applications this field will indicate in which language the user is inputting text.

F: Language OUT Field

In the case of text input this field will indicate the requested output language of the text translation and audio files

H: Gender Field

This will indicate that the user has requested the audio files be played in either a male or female voice.

I: Routing Field

This will define the preferred routing of text and audio for processing, as well as defined storage folders for text and audio files.

The Event data module 400 can contain a multitude of data fields, which can initiate programs, which can control all IVR functions and applications. The call control management 401 controls an audio file module 405 which delivers audio to either the incoming call or outgoing call connection 403,404.

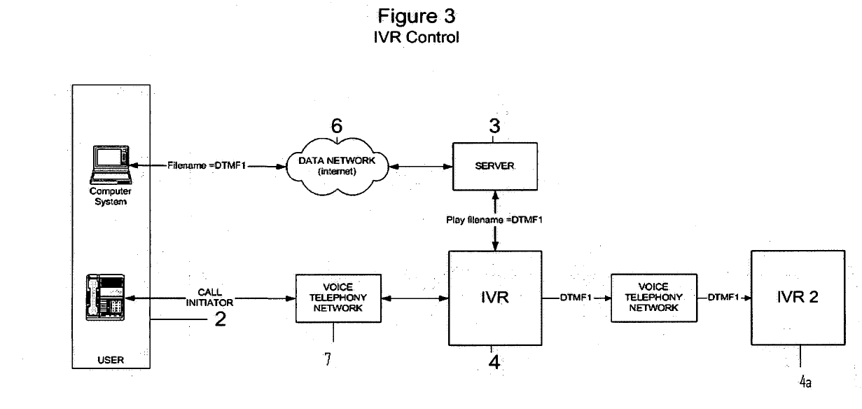

It will be appreciated that the invention can be implemented to control the output from any current IVR system 4 via a web interface as illustrated in FIG. 3. When a telephone is connected to the IVR system 4, the internet based output can be interpreted by the IVR system 4 as a telephone key press and used to control telephone based IVR applications. The invention will present each menu level in a visual form on a web page. The user can call the IVR application using a normal telephone or mobile phone. When the user clicks on the web page, the invention will send text data corresponding to an individual or series of DTMF tone to the IVR system 4 via the web server 3. The IVR system 4 will interpret the text and user's telephone application and will respond according to the equivalent telephone keypad pressed by the user. The user can then visually navigate the IVR system 4 menu structure in a much more ergonomic manner. This is particularly applicable to mobile phones as they do not need to be removed from the ear in order to press the keypad. The users calling line identifier (CLI) can be stored on the web page. Subsequent data submissions from the web page will include an identifier based on the CLI information. The user dials a specific number to access the IVR system 4. The CLI data, together with the dialled number to the IVR system, provides a method of routing the output of the server 3 via the IVR system 4 to the correct telephone connection.

Additionally it is possible for the UVR system 4 to connect to other IVR systems 4a to access other information in response to an event initiated by the call initiator 2. In this case audio files representing valid DTMF tones are played by the IVR system 4 to the telephony input of IVR system 4a.

It will also be appreciated that each user accessing the same UVR application will have an activated CLI to generate a unique identifier. It will be appreciated that other identifiers beside CLI can be used as long as the web interface and IVR application are in compliance with this identifier. Other identifiers can be uses to generate the unique identifier for example the Out Dialled Number (ODN), a cookie associated with one of the users, an IP address or a browser script. These identifiers can be entered separately on the web page and entered on the telephone keypad when requested by the IVR program, associated with the IVR system 4. Software stored on the IVR system 4 can then maintain a direct link between requests made on a web page and outputs to the correct telephone connection.

It is also possible for the IVR system 4 to send a unique identifier directly to the user, which can be shown or hidden. If they do not enter any telephone number it is possible to show this identifier to the user and use the voice connection to request the user to enter this identifier by keying in numbers on the telephone handset, which is then used as the identifier.

Alternatively the IVR system 4 can inform the user over the voice call to enter an identifier on the webpage. This identifier would relate to the current voice channel the caller is using and uniquely identify event data from the internet.

The invention provides for music listening without downloads as illustrated in FIG. 3. Currently, it is possible to call a special number and listen to sample track of popular songs and music. The caller is requested to enter several key presses before the required audio is played over the phone. This is cumbersome and limited to twelve phone keys. The invention will allow the caller to interact visually with the available tracks by presenting the audio application as visual information on the users device. A user can send an internet application to a first IVR system 4, which links to a second IVR system 4a storing the music application. The selected audio application from the second IVR system is converted to visual information at the second IVR system, for example in the form of a menu. This menu is presented on the users device. The user can select an option from the menu which triggers the delivery of an audio application over the voice call to the user. This is achieved by the user by selecting a portion of the visual information by clicking the appropriate icon or hyperlink on the users device or computer. The user can listen to the music over the current voice call without actually downloading the music application.

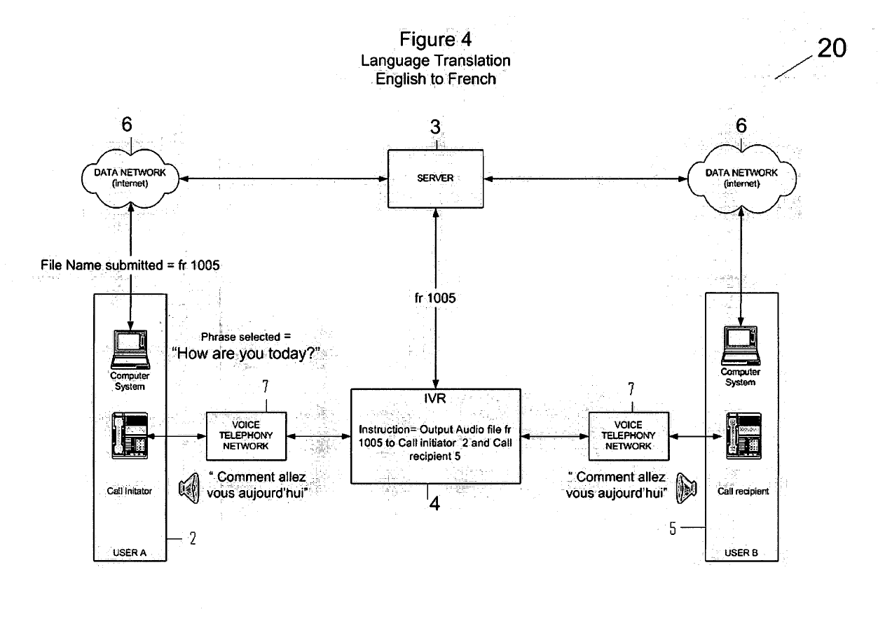

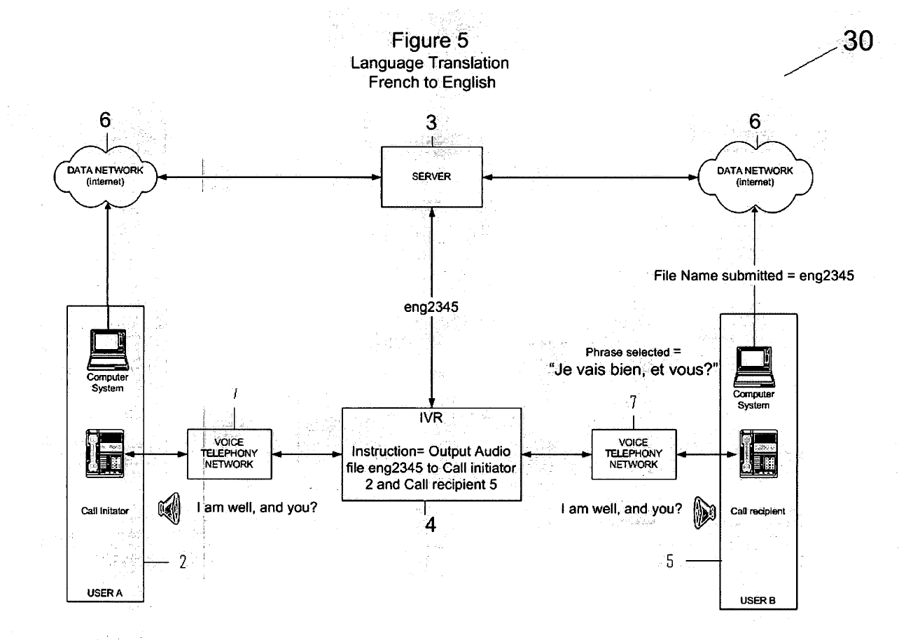

Referring now to FIGS. 4 and 5, indicated generally by the reference numerals 20 and 30 respectively, there is identified a language translation application of the present invention. The caller selects a phrase to send, in this case “how are you today”. The web server 3 receives the corresponding file name only, for example, FR1005. The web server 3 sends the file name to the IVR system 4. The IVR system 4 recognises the file name and plays the matching audio file over the appropriate telephone connection to both parties. The audio file played over the telephone connection is a pre-recording of “comment allez vous aujourd'hui”. The result is that the English speaker has asked the recipient “how are you today”. The recipient hears only “comment allez vous aujourd'hui”, the direct translation of “how are you today” into French in real time.

The French speaking caller recipient 5 connected to the internet wishes to reply to the phrase “comment allez vous aujourd'hui” and selects the phrase “je vais bien, et vous”. The corresponding file name, for example, eng2345 is sent over the internet to the web server 3. The file name eng2345 is sent to the local IVR system 4. The IVR system 4 recognises the file name and plays the matching audio file over the appropriate telephone connection to both parties. The audio file played over the telephone connection is a pre-recording of “I am well, and you?”. The result is that the French speaker has replied to the English phrase “how are you?”. The English speaker hears only “I am well, and you?”.

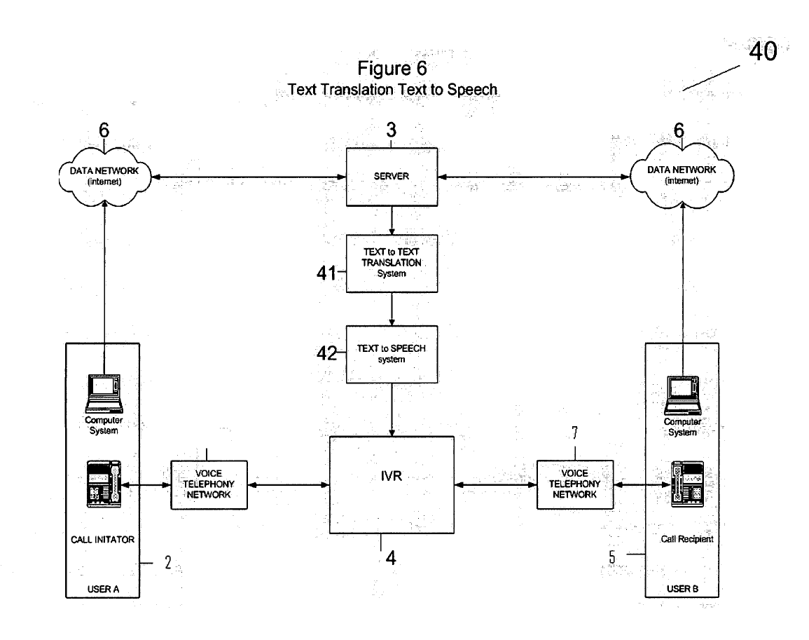

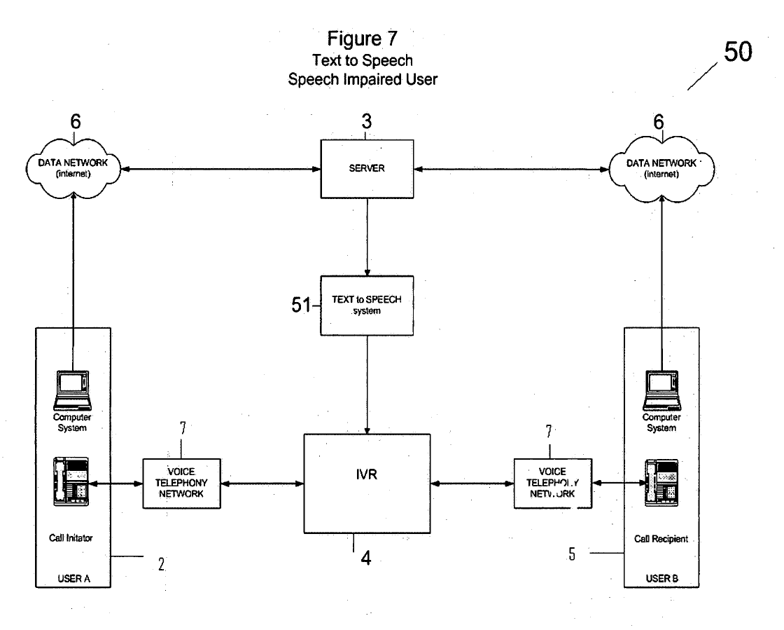

Referring now to FIGS. 6 and 7, indicated generally by the reference numerals 40 and 50, illustrate a text to speech with a translation application. The speech impairment application includes the facility by which a user can input the text of the audio file to be played using a computer keyboard. Then using a text-to-speech (TTS) system the resulting audio file is played over the associated live telephone connection. Normally, a speech impaired person will click icons on a web page and the pre-recorded audio will be played over the current telephone connection. There will be occasions when the user will need to express something which is not available as a pre-recorded audio file. In this instance, the user can type the required text on the web page. A search is performed on the IVR system 4 to determine if an audio file matching the text is available. If a match is found on the audio file, it is retrieved and played immediately by the IVR system 4 over the telephone line. If no match is found, the text is submitted for processing to the text-to-speech system 51. The resulting TTS audio file will be delivered to the IVR system 4. The TTS audio is immediately played over the telephone to the connected users. The audio file and text is stored on the IVR system for future and subsequent use. Subsequent text matches will access and play the pre-recorded audio file immediately. Therefore, it will not need to be processed again by the TTS system. A user can choose to change the audio output, for example, from a male to female voice.

Referring again to FIG. 6, a user submits text to be converted to audio in a chosen language. The user can type the required text on the web page and submit it to the server 3. In this case, the text is first translated into equivalent text in the language specified by the user 41. The translated text is sent to the TTS system 42, specified for that language. The resulting translated audio output is played by the IVR system 4 over the associated live telephone connection.

A status protocol is provided between the IVR system and the telephone users, for example by means of CGI, ASP or other scripts on the server 3 which can interrogate the call data management module 403 of the IVR system 4. The results of the interrogation can be formatted and returned via the server 3 to the user as call status information. The protocol can be configured to visually indicate to the users the status of a current voice call via the users computer. This is important for deaf users who cannot hear whether a voice connection has been made. Additionally the invention provides a visual indication procedure to establish a call. For example, a hearing impaired person can click pre-defined icons or input to a text-to-speech system 51, illustrated in FIG. 7, when using the present invention. The resulting audio will be played over a connected telephone system to the call recipient. In this case, speech coming from the recipient into the IVR system 4 can be sent to a speech-to-text system. This will output a text string corresponding to the words spoken by the recipient. This text output is then viewed by the hearing impaired person on the connected computer. All the time during the call connection the status can be visually indicated to the hearing impaired or deaf user.

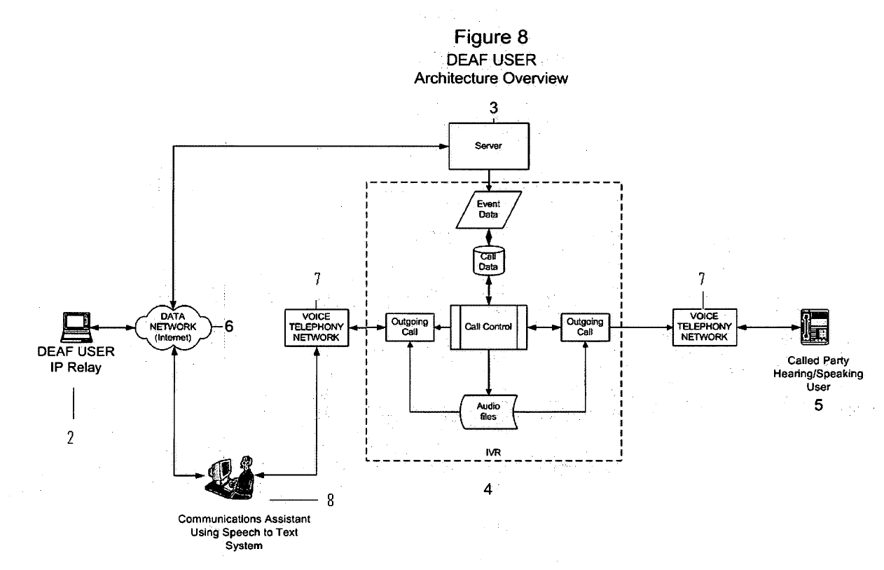

FIG. 8 illustrates an alternative architecture of the present invention for use in a TRS service by a hearing impaired or deaf user. For Hearing impaired or Deaf individuals the proficiency of a communications assistant (CA) is improved. IP Relay services are faster with reduced latency. One of the problems of TRS services for Deaf individuals is the conversation latency caused by the requirements of:

a) The User needs to type the complete text.

b) The CA must Voice the text to the hearing person.

c) The hearing person to reply to the CA

d) The CA must then type the complete response to the User.

By implementing the present invention a CA is no longer required to voice the text to a hearing person. This affords the opportunity for the CA to improve relay speeds by applying Speech Recognition software without interfering with the conversation flow. This can significantly improve text input when compared to typing. Speech recognition requires less CA training than that required for a typing proficiency of 60 words per minute. The perception of privacy is improved as neither the IP relay user or the hearing recipient is directly aware of the CA. The sex of the CA is not relevant, the user can choose a male or female TTS (Text to Speech) output. Users can store frequently used phrases. The output voices are consistent and recognisable to regular recipients such as friends and families of TRS users.

It will be appreciated that while IVR systems have been discussed in this specification other telephone switching mechanisms can be used.

It will be appreciated that the present invention improves the overall efficiency of the Telecommunications Relay Service for speech impaired individuals. The caller can choose a male or female voice at will. TRS services may not always have CA of the requested sex available. Users can choose to input text in another language, without the need for a CA conversant in that language. Users can store frequently used phrases such as name, address, or TRS explanations and information. There is a greater perception of privacy as there is no third party involved in the conversation. The output voices are consistent and recognisable to regular recipients such as friends and families of TRS users.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means

The invention is not limited to the embodiment hereinbefore described, but may be varied in both construction and detail.

The words “comprises/comprising” and the words “having/including” when used herein with reference to the present invention are used to specify the presence of stated features, integers, steps or components but does not preclude the presence or addition of one or more other features, integers, steps, components or groups thereof.

I claim:

1. A method of introducing events into a current voice call of a telephone between at least two telephone users in a telecommunications network comprising:
routing said voice call via an Interactive Voice Response (IVR) system;
linking said interactive voice response (IVR) system to a server in response to an input from an internet application initiated by at least one of said telephone users;
recognising the input as an event by the IVR system;
outputting the event over said current voice call; and
wherein said event is an audio file associated with said IVR system which is delivered over said current voice call to at least one telephone user in response to the input initiated by one or other of said other telephone users.

2. The method of claim 1 wherein said input comprises the step of selecting an icon or hyperlink by one of said telephone users from a web page on a computer screen triggering the event connected to the server and the IVR system.

3. The method of claims 1 or 2 comprising the further steps of accepting inputs from said web pages to an IVR system and outputting as an event to a selected current voice call connection.

4. The method of claim 1 comprising the step of providing a VoIP channel for said current voice call.

5. The method of claim 1 comprising the steps of:
storing a plurality of audio files on said IVR system;
receiving at said IVR system said input from said server; and
outputting said audio file from said input, been recognised as an event by said IVR system, over said current voice call selected from said plurality of audio files in response to said event in real time.

6. The method of claim 1 comprising the step of allowing multiple voice call connections interact with the IVR system simultaneously from several web pages.

7. The method of claim 1 comprising the further step assigning an identifier to route the audio file to said voice call in response to said event wherein said IVR system selects said audio file from said event when an event is received by said IVR system.

8. The method of claim 7 comprising the step of providing a unique identifier, said identifier is generated from an Out Dialled Number (ODN), from the IVR to one of said telephone users receiving a telephone voice call.

9. The method of claim 7 comprising the step of providing a unique identifier, said identifier is generated from a Call Line Identifier (CLI), identified from one of said telephone users initiating a telephone voice call.

10. The method of claim 7 comprising the step of providing a unique identifier, said identifier is generated from a cookie or IP address or a browser script, identified from one of said telephone users initiating a telephone voice call

11. The method of claim 1 comprising the further steps of:
inputting text to said web server over an internet application by at least one of said telephone user;
assigning a file name to said inputted text;
transmitting said file name to said IVR system said filename been recognised as an event; and
outputting an audio file from said IVR system representing said inputted text over said current voice call to said other user.

12. The method of claim 1 comprising the additional steps of:
inputting audio information to a speech to text module via said IVR system by at least one of said telephone users;
outputting a text string by said server representing said inputted audio information to an interface viewable by said other user.

13. The method of claim 1 comprising the steps of:
providing a status protocol between said IVR system and said telephone users; and
configuring said protocol to visually indicate to said users the status of said current voice call connection via an internet enabled screen of said users.

14. A method of introducing events into a current voice call of a telephone between at least two telephone users in a telecommunications network comprising:
routing said voice call via an interactive voice response (IVR) system;
linking said interactive voice response (IVR) system to a server in response to an input from an internet application initiated by at least one of said telephone users;
selecting a translation application by at least one of said users;
inputting text to be translated by said user on said server to provide an event;
receiving at said IVR system said event from said server;
outputting the event over said current voice call; and
wherein said event is an audio file associated with said IVR system which is a translation of said inputted text to at least one telephone user in response to said selected translation application.

15. The method of claim 14 comprising the step of utilising a single voice call to provide a two way simultaneous translation between said at least two users.

16. The method of claim 14 comprising the step of providing a unique identifier for each call connection.

17. The method of claim 16 comprising the step of routing an associated event to the correct voice call from said identifier.

18. The method of claim 14 comprising the step of providing a unique identifier, said identifier is generated from an Out Dialled Number (ODN), from the IVR to one of said telephone users receiving a telephone voice call.

19. The method of claim 14 comprising the step of providing a unique identifier, said identifier is generated from a Call Line Identifier (CLI), identified from one of said telephone users initiating a telephone voice call.

20. The method of claim 14 comprising the step of providing a unique identifier, said identifier is generated from a cookie or IP address or a browser script, identified from one of said telephone users initiating a telephone voice call.

21. The method of claim 14 comprising the steps of:
providing a status protocol between said IVR system and said telephone users; and
configuring said protocol to visually indicate to said users the status of said current voice call connection via an internet enabled screen of said users.

22. The method of claim 21 wherein said status protocol comprises the step of:
visually indicating to said user that no call connection has been made; and
visually indicating a procedure to establish a call connection between said users.

23. The method of claim 21 wherein said status protocol comprises the steps of:
visually indicating to said user that a call connection has been made; and
visually indicating the readiness of said voice call connection to accept an input from one of said users.

24. A method of controlling an audio output from an IVR system outputted to a users device by a visual control means comprising the steps of:
linking a first IVR system to a second IVR system in response to an input from an internet application initiated by a user;
selecting an audio application associated with said second IVR system in response to said input;
converting said audio application to visual information at said first IVR system;
presenting said audio application as a visual information on said users device from said first IVR system; and
selecting a portion of said visual information by said user wherein said selected portion of information triggers a desired audio output to be delivered to said user over a voice call.

25. The method of claim 24 comprising the additional steps of:
initiating said voice call between said user and said IVR system; and
delivering a selected audio application to said user from said IVR system over said voice call.

26. A computer program, comprising program instructions for causing a computer to perform the method of claim 1.

27. A computer program as claimed in claim 26 embodied on a record medium.

28. A computer program as claimed in claim 26 embodied on a carrier signal.

29. A computer program as claimed in claim 26 embodied on a read-only memory.

30. A system for introducing events into a current voice call of a telephone between at least two telephone users in a telecommunications network comprising:
means for routing said voice call via an Interactive Voice Response (UVR) system;
means for linking said interactive voice response (IVR) system to a server in response to an input from an internet application initiated by at least one of said telephone users;
means for recognising the input as an event by the IVR system;
means for outputting the event over said current voice call; and
wherein said event is an audio file associated with said IVR system which is delivered over said current voice call to at least one telephone user in response to the input initiated by one or other of said other telephone users.

31. The system of claim 30 wherein said input is selected from an icon or hyperlink by one of said telephone users from a web page on a computer screen triggering the event connected to the server and the IVR system.

32. The system of claim 30 comprising means for accepting inputs from said web pages to an IVR system and outputting as an event to a selected current voice call connection.

33. The system of claim 30 comprising means to provide a VoIP channel for said current voice call.

34. The system of claim 30 comprising means for storing a plurality of audio files on said IVR system; means for receiving at said IVR system said input from said server; and means for outputting said audio file from said input, been recognised as an event by said IVR system, over said current voice call selected from said plurality of audio files in response to said event in real time.

35. The system of claim 30 comprising connection means to allow multiple voice call connections interact with the IVR system simultaneously from several web pages.

36. The system of claim 30 comprising identifying means to route the audio file to said voice call in response to said event wherein said IVR system selects said audio file from said event when an event is received by said IVR system.

37. The system of claim 36 wherein there is provided a unique identifier, said identifier is generated from an Out Dialled Number (ODN), from the IVR to one of said telephone users receiving a voice call.

38. The system of claim 36 wherein there is provided a unique identifier, said identifier is generated from a Call Line Identifier (CLI), identified from one of said telephone users initiating a voice call.

39. The system of claim 36 wherein there is provided a unique identifier, said identifier is generated from a cookie or IP address or a browser script, identified from one of said telephone users initiating a voice call.

40. The system of claim 30 comprising means for inputting text to said server over an internet application by at least one of said telephone user; means for assigning a file name to said inputted text; means for transmitting said file name to said IVR system said filename been recognised as an event; and means for outputting an audio file from said IVR system representing said inputted text over said current voice call to said other user.

41. The system of claim 30 comprising means for inputting audio information to a speech to text module via said IVR system by at least one of said telephone users; and means for outputting a text string by said server representing said inputted audio information to an interface viewable by said other user.

42. The system of claim 30 comprising means for providing a status protocol between said IVR system and said telephone users; and means for configuring said protocol to visually indicate to said users the status of said current voice call connection via an internet enabled screen of said users.

43. A system for introducing events into a current voice call of a telephone between at least two telephone users in a telecommunications network comprising:
means for routing said voice call via an interactive voice response (IVR) system;
mean for linking said interactive voice response (IVR) system to a server in response to an input from an internet application initiated by at least one of said telephone users;
means for selecting a translation application by at least one of said users;
means for inputting text to be translated by said user on said server to provide an event;
means for receiving at said IVR system said event from said server;
means for outputting the event over said current voice call; and
wherein said event is an audio file associated with said IVR system which is a translation of said inputted text to at least one telephone user in response to said selected translation application.

44. The system of claim 43 comprising means for utilising a single voice call to provide a two way simultaneous translation between said at least two users.

45. The system of claim 43 wherein there is provided a unique identifier for each call connection.

46. The system as claimed in claim 43 comprising means for routing an associated event to the correct voice call from said identifier.

47. The system of claim 45 wherein said identifier is generated from an Out Dialled Number (ODN), from the IVR to one of said telephone users receiving a voice call.

48. The system of claim 45 wherein said identifier is generated from a Call Line Identifier (CLI), identified from one of said telephone users initiating a voice call.

49. The system of claim 45 wherein said identifier is generated from a cookie or IP address or a browser script, identified from one of said telephone users initiating a voice call.

50. The system of claim 43 comprising means for providing a status protocol between said IVR system and said telephone users; and means for configuring said protocol to visually indicate to said users the status of said current voice call connection via an internet enabled screen of said users.

51. The system of claim 50 wherein said status protocol comprises means for visually indicating to said user that no call connection has been made; and means for visually indicating a procedure to establish a call connection between said users.

52. The system of claim 50 wherein said status protocol comprises means for visually indicating to said user that a call connection has been made; and visually indicating the readiness of said voice call connection to accept an input from one of said users.

53. A system for controlling an audio output from an IVR system outputted to a users device by a visual control means comprising the steps of:
means for linking a first IVR system to a second IVR system in response to an input from an internet application initiated by a user;
means for selecting an audio application associated with said second IVR system in response to said input;
means for converting said audio application to visual information at said first IVR system;
means for presenting said audio application as a visual information on said users device from said first IVR system; and
means for selecting a portion of said visual information by said user wherein said selected portion of information triggers a desired audio output to be delivered to said user over a voice call.

54. The system of claim 53 comprising means for initiating said voice call between said user and said IVR system; and means for delivering a selected audio application to said user from said IVR system over said voice call.
